(19) United States
(12) Patent Application Publication
(10) Pub. No.: US 2018/0272860 A1
(43) Pub. Date: Sep. 27, 2018

(54) MULTI-LAYER COMPOSITE MATERIAL FOR PRODUCING PLASTIC MOLDED PARTS, CONTAINER COMPOSED OF SUCH A COMPOSITE MATERIAL, AND METHOD FOR PRODUCING THE CONTAINER

(71) Applicant: KAUTEX TEXTRON GMBH & CO. KG, Bonn (DE)

(72) Inventor: Ulrich KARSCH, Niederkassel (DE)

(21) Appl. No.: 15/764,172

(22) PCT Filed: Sep. 28, 2016
(86) PCT No.: PCT/EP2016/073105

§ 371 Date: Mar. 28, 2018

(30) Foreign Application Priority Data
Sep. 28, 2015 (DE) 10 2015 218 584.2
Nov. 17, 2015 (DE) 10 2015 222 668.9

(51) Int. Cl. B60K 15/03; B29C 47/06

(52) U.S. Cl. CPC B60K 15/03177; B32B 27/08; B29C 47/065; B29C 47/067

(57) ABSTRACT

The invention relates to a multilayer composite material for the production of plastics moldings, to a container made of this composite material, and also to a process for the production of the container. The composite material comprises a first structure-providing self-supporting rigid external layer made of a fiber composite material, a second structure-providing external layer, a first intermediate layer made of a barrier plastic and a second cracking-resistant intermediate layer made of a thin cracking-resistant film, and also at least one adhesion promoter layer, where the intermediate layers and the adhesion promoter layer have been embedded between the structure-providing external layers and form an adhesion bond with the structure-forming external layers, and where the thickness of each of the structure-providing external layers is many times the thickness of each of the intermediate layers or of the adhesion promoter layer.

### FIELD

The invention relates to a multilayer composite material for the production of plastics moldings. The invention in particular relates to a multilayer composite material for the production of pressure-tight thin-walled containers, for example fuel containers for motor vehicles.

The invention moreover relates to a process for the production of a container made of a multilayer composite material.

### BACKGROUND

Weight reductions are particularly important in the development of plastics moldings for automobile applications. However, dimensional stability of plastics moldings in automobile construction is also critical, in particular in the production of containers installed in motor vehicles, examples being fuel containers, urea containers and other ancillary liquid containers.

These containers, in particular plastics fuel containers, are often single- or multipart containers based on polyethylene (HDPE). Fuel containers for gasoline in particular have a multilayer wall structure with barrier layers for hydrocarbons or are resistant to hydrocarbons as a consequence of chemical treatment.

Plastics fuel containers based on HDPE have the advantage of being amenable to production with a relatively complex three-dimensional shape, and of having adequate stability, including dimensional stability. These plastics containers also have adequate impact resistance, and can therefore withstand impact forces in the event of a collision. Short-term deformation effects suffered by a plastics container in the event of a collision do not generally lead to long-lasting changes of shape. The known plastics fuel containers are also very substantially dimensionally stable in respect of short-term increases in internal pressure, at least insofar as they return to their original shape when pressure decreases.

However, thermoplastics have the disadvantage that they are susceptible to creep on exposure to deformation forces of longer duration.

Materials based on HDPE, in either single-layer or multilayer format, are therefore not per se generally suitable for the production of containers which have to withstand increased internal pressure over a prolonged period. A pressure increase of the magnitude of as little as about 400 mbar over a prolonged period leads to long lasting deformation effects in the material of a container based on HDPE.

Containers and moldings made of polyethylene or made with polyamide or based on polyethylene moreover have the disadvantage that adequate stability can be achieved only by way of appropriately high wall thicknesses of the components. In plastics moldings of this type there are only limited possibilities for achieving weight reductions solely via design measures, and plastics moldings made of fiber composite materials are therefore also increasingly important in automobile construction.

DE 10 2010 027 096 A1 by way of example discloses a fuel container made of plastic with a multilayer container wall which comprises an interior layer made of thermoplastic having an external layer made of a fiber composite material. There is a coherent bond between these layers, and a multilayer extrudate based on polyethylene, with a barrier layer for hydrocarbons, is provided as interior layer here.

This type of composite material has the advantage that the container produced therefrom has an externally situated relatively rigid and lightweight layer, whereas the interior layer has a degree of pliability and in particular ensures that the container is leakproof.

However, when fiber composite materials such as high-strength organopanels are exposed to deformation forces resulting from an impact at low temperatures they are susceptible to brittle fractures.

Experience has shown that in a combination of hard, brittle plastics layers and ductile plastics layers coherently bonded to one another and thus forming a laminate, cracking in the hard and brittle layer tends to propagate in the ductile layer unless the ductile layer has a certain wall thickness. It is therefore not possible to achieve significant weight reductions in plastics moldings made of a composite material such as that described by way of example in DE 10 2010 027 096 A1 by reducing layer thicknesses of the materials forming the composite.

DE 10 2013 004 931 A1 discloses a process for the production of a fuel container based on thermoplastic, where the process comprises the production of semifinished sheet products made of a fiber composite material and a matrix made of thermoplastic, the lamination of the semifinished products to a laminate which comprises at least one barrier for hydrocarbons, the heat-treatment of the laminate in semifinished products as far as plastification of the thermoplastic, the thermoforming of the semifinished products in a thermoforming mold to give shells and the joining of the shells in a closed container.

Further prior art is disclosed in the documents DE 10 2010 027 096 A1 and DE 10 2013 004 929 A1.

### SUMMARY

The invention is therefore based on the object of providing a multilayer composite material which is particularly lightweight and resistant to fracture for the production of plastics parts, in particular the containers, for example of fuel containers or other service liquid containers for motor vehicles. The composite material is moreover also intended to have barrier properties, i.e. in essence to prevent molecular transport of liquid and gaseous substances through the material.

The invention moreover provides a container made of this multilayer composite material. Finally, the invention also comprises a process for the production of this container made of a multilayer composite material of the invention.

One aspect of the invention provides a multilayer composite material for the production of plastics moldings comprising:
a first structure-providing, self-supporting rigid external layer made of a fiber composite material,
a second structure-providing external layer,
a cracking-resistant intermediate layer made of a plastic selected from a group, comprising cracking-resistance-modified polyethylene, polyisobutylene, polyvinyl butyral, ethylene-vinyl acetate, polyacrylate, polymethylene acrylate, polyurethane, prestretched polypropylene, polyvinyl acetate and
at least one adhesion promoter layer,
where the intermediate layer and the adhesion promoter layer have been embedded between the structure-providing external layers and form an adhesion bond with the structure-providing external layers, and where the thickness of each of the structure-providing external layers is many times the thickness of the intermediate layer or of the adhesion promoter layer.

In particular, fracture energy introduced into the composite material is absorbed by the cracking-resistant intermediate layer with the result that, by way of example, if the first structure-providing self-supporting rigid external layer cracks, this cracking does not propagate in the other layers of the composite material. For the purposes of the invention, a cracking-resistant intermediate layer is a thin cracking-resistant film with a tensile strain at break of >300%.

Materials that can be used as cracking-resistant intermediate layer are thin, cracking-resistant films which form a coherent bond, i.e. an adhesive bond, with the layers surrounding same. The effect of the cracking-resistant intermediate layer is therefore that it always acts to retain the integrity of the laminate, the overall result therefore being that the multilayer composite material has high resistance to fracture with low thickness of material. The thickness of the cracking-resistant intermediate layer is about 50 μm to 1520 μm, particularly preferably from 50 μm to 300 μm.

The second structure-providing external layer can in principle likewise consist of a fiber composite material.

For the purposes of the present invention, the multilayer composite material can in principle comprise a large number of structure-providing and self-supporting rigid layers, with cracking-resistant intermediate layers arranged between each of these.

Although for the purposes of the present invention the structure-providing external layers can also form outermost layers, and this is also preferred, the invention also provides that there can also be further layers based on the structure-providing external layers, with the result that the structure-providing external layers do not necessarily form the outermost layers.

The second structure-providing external layer can comprise one or more thermoplastics selected from a group comprising polyethylenes, polyamides, polyphenylene sulfides, polybutylene terephthalates, polyketones, polyetheretherketones, liquid-crystal polymers and polyphthalamides.

The second structure-providing external layer can consist of a polyolefin or of a polyamide, and its thickness can by way of example be from 0.5 to 1.5 mm

A preferred variant of the multilayer composite materials described above provides that the second structure-providing external layer is an HDPE layer (high-density polyethylene) or a PA layer. This layer made of HDPE or PA (polyamide) can by way of example serve as protective layer for an intermediate layer made of a barrier plastic, or as what is known as welding reserve. The expression welding reserve is generally used for plastics-molding layers that enable welding to other plastics moldings without provision of additional welding materials or of adhesives.

Fiber composite material provided for the purposes of the present invention comprises a material with a thermoplastic or thermoset matrix with, embedded therein, long fibers or what are known as “continuous-filament fibers”, where the long fibers or continuous-filament fibers are selected from the group comprising glass fibers, carbon fibers and aramid fibers, and the long fibers or continuous-filament fibers have been woven or laid.

For the purposes of the present invention a long fiber means a fiber of length from 1 mm to 50 mm. For the purposes of the present invention, a continuous-filament fiber means a fiber length more than 50 mm.

For the purposes of the present invention, the expression laid long fiber or laid continuous-filament fiber means an arrangement of long fibers or continuous-filament fibers where these have no bonding via what are known as warp and weft fibers in the manner of a woven fabric. The above expression means an unbonded directional and layered arrangement of long fibers or continuous-filament fibers in the matrix material.

For the purposes of the present invention, what are known as organopanels can in particular be used as fiber composite material. The term organopanels generally means a semifinished fiber-matrix product which comprises a woven fiber fabric or a laid fiber fabric embedded into a thermoplastic matrix. A laid fiber fabric is defined here as an arrangement of laid long fibers or continuous-filament fibers.

The multilayer composite material of the invention preferably moreover comprises a further intermediate layer made of a barrier plastic.

For the purposes of the present invention, a barrier plastic means a plastic which is not, or in essence not, porous to liquid and gaseous substances, i.e. through which no significant molecular transport of liquid and gaseous substances, i.e. permeation thereof, takes place.

The barrier plastic can by way of example be selected from the group comprising polyvinylidene chloride (PVDC), ethylene-vinyl alcohol copolymer (EVOH), liquid-crystal plastic (LCP), polyamide 6 (PA 6), cellulose and biaxially oriented polypropylene (BOPP).

EVOH is particularly suitable as barrier plastic.

Adhesion promoter provided comprises by way of example a maleic-anhydride modified LDPE (Low Density Polyethylene) or an LLDPE.

In one variant of the invention, the multilayer composite material features a layer structure comprising, in the following sequence, an exterior layer made of a thermoplastic selected from the group comprising polyethylene, polyamides, polyphenylene sulfides, polybutylene terephthalates, polyketones, polyetheretherketones, liquid-crystal polymers and polyphthalamides, a cracking-resistant intermediate layer and a layer made of a fiber composite material.

The fiber composite material itself can be of multilayer design, and there can be a cracking-resistant intermediate layer arranged here between respective individual fiber layers, each embedded into a matrix material in the form of a thermoplastic or thermoset plastic.

In another variant of the invention, the multilayer composite material can comprise a layer structure comprising, in the following sequence, an exterior layer made of a plastic selected from a group comprising polyethylene, polyamides, polyphenylene sulfides, polybutylene terephthalates, polyketones, polyetheretherketones, liquid-crystal polymers and polyphthalamides, an adjacent first adhesion promoter layer, an intermediate layer made of a barrier plastic, a second adhesion promoter layer, a cracking-resistant intermediate layer and optionally a third adhesion promoter layer, and also a structure-providing external layer made of a fiber composite material.

The thickness of the structure-providing layers can in principle be from 0.5 mm to 2 mm, preferably from 1 to 1.5 mm, whereas the thickness of the intermediate layers, i.e. both the intermediate layer made of barrier plastic and the cracking-resistant intermediate layer, and also the adhesion promoter layer, can respectively be from 50 μm to 1520 μm.

A further aspect of the present invention provides a container made of a multilayer composite material of the type described above, where the first structure-providing external layer is an external layer of the container and where the second structure-providing external layer is an internal layer of the container.

In particular, if the second structure-providing external layer consists of HDPE or PA, it is readily possible to produce the container of the invention from a plurality of shells which are welded to one another with internal layers mutually superposed.

A preferred embodiment of the container of the invention is designed as fuel container for a vehicle.

As already mentioned above, the container can be composed of two shell-shaped moldings comprising an upper shell and a lower shell, where the upper shell and the lower shell can have been welded to one another by way of example at edges designed in the manner of flanges. The respective expressions “upper shell” and “lower shell” refer to the installed position of the container.

The invention moreover provides a process for the production of a container made of a multilayer composite material with the features described above, where the process comprises the following steps:
provision of semifinished fiber-matrix products as fiber composite material,
heating and plastification of the semifinished fiber-matrix products,
molding of the semifinished fiber-matrix products to give shell-shaped intermediate products,
provision of a multilayer plastified extrudate comprising a structure-providing external layer made of a thermoplastic selected from a group comprising polyethylene, polyamides, polyphenylene sulfides, polybutylene terephthalates, polyketones, polyetheretherketones, liquid-crystal polymers and polyphthalamides and at least one intermediate layer,
introduction of the plastic extrudate into the plastified and molded semifinished fiber-matrix product and coherent bonding of the semifinished fiber-matrix product and of the extrudate with utilization of the heat of plastification and/or by means of an adhesion promoter.

The multilayer extrudate can comprise a plurality of intermediate layers, at least one intermediate layer of which can consist of a barrier plastic.

When the semifinished fiber-matrix product and the extrudate are bonded with utilization of the heat of plastification, the introduction of plastic extrudate into the plastified and molded semifinished fiber-matrix product and the coherent bonding of the semifinished fiber-matrix product and of the extrudate take place almost simultaneously.

The extrudate can by way of example be provided in a known manner as coextrudate from an extrusion head of an extrusion blow molding machine.

The process can in principle comprise the plastification of semifinished fiber-matrix products with a thermoplastic matrix, the introduction of these semifinished fiber-matrix products into an extrusion blow mold and what is known as blown injection of a multilayer extrudate in the extrusion blow mold onto the semifinished fiber-matrix product already shaped in the mold.

The invention also comprises the lamination of a multilayer composite material of the present invention to semifinished sheet products which are then molded in a second heating procedure, i.e. via reheating, to give shell-shaped intermediate products. In this case, the shell-shaped intermediate products can by way of example be produced by means of conventional thermoforming equipment.

### BRIEF DESCRIPTION OF THE DRAWINGS

The invention is explained below with reference to an embodiment depicted in the drawings.

FIG. 1 shows a layer structure of a multilayer composite material of a first embodiment of the invention and

FIG. 2 shows a layer structure of a multilayer composite material of a second embodiment of the invention.

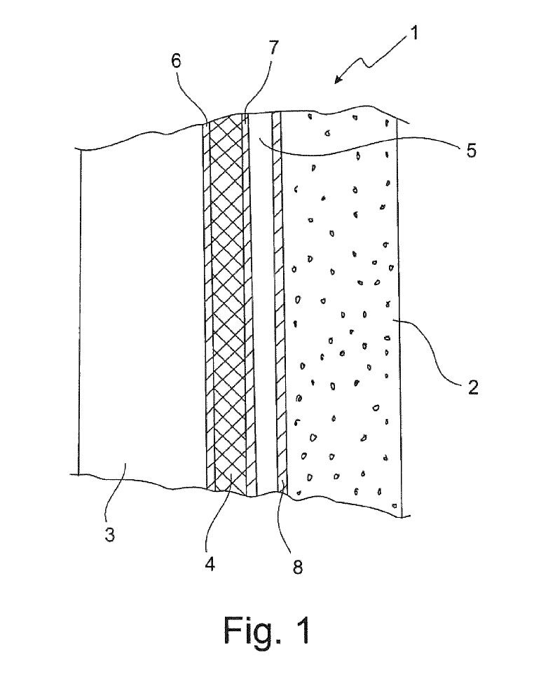

A layer structure of a multilayer composite material of the invention is depicted by way of example in the attached FIG. 1.

### DETAILED DESCRIPTION

FIG. 1 shows a diagrammatic layer structure of a composite material 1 of the invention comprising a first structure-providing external layer 2 made of a fiber composite material and a second structure-providing external layer 3 made of an HDPE. The layer section depicted in FIG. 1 also shows the wall structure of a container of the invention. The first and second structure-providing external layers 2 and 3 are respectively outermost layers of the container wall, where the first structure-providing external layer 2 forms an external side of the container and the second structure-providing external layer 3 forms an internal side of the container.

Between the first structure-providing external layer 2 and the second structure-providing external layer 3, the arrangement has first and second intermediate layers 4 and 5, respectively designed as thin films with layer thickness from 50 to 300 μm. These layers are correspondingly flexible and are not structure-providing layers for the purposes of the invention. The second intermediate layer 5 is designed as cracking-resistant intermediate layer for the purposes of present invention, whereas the first intermediate layer 4 consists of a barrier plastic.

The first structure-providing external layer 2 consists of a fiber composite material with continuous-filament fiber embedded in a thermoplastic matrix, and the second structure-providing external layer 3, which forms the internal layer of the container, consists of an HDPE. The first structure-providing external layer 2 and the structure-providing external layer 3 of self-supporting rigid design and respectively have a layer thickness of about 0.5 to 2 mm

Although the first structure-providing external layer 2 forms the external side of the container, the invention is to be understood as providing the possibility of a protecting coating externally provided to this first structure-providing external layer 2.

In the embodiment described it is preferable that the first intermediate layer 4 is an EVOH layer (ethylene-vinyl alcohol copolymer), embedded into a first and second adhesion promoter layer 6, 7.

The second intermediate layer 5 consists by way of example of a polyisobutylene, and is designed as cracking-resistant intermediate layer or film for the purposes of the invention.

The second intermediate layer 5 has been embedded between the second adhesion promoter layer 7 and a third adhesion promoter layer 8, so that adhesion bonding of the laminate is achieved across the second intermediate layer 5.

The second intermediate layer 5, as thin, cracking-resistant film, absorbs the deformation fracture energy by way of example when the first structure-providing external layer 2 is exposed to an impact, so that the cracks that form cannot propagate into the first intermediate layer 4 and into the second structure-providing external layer 3.

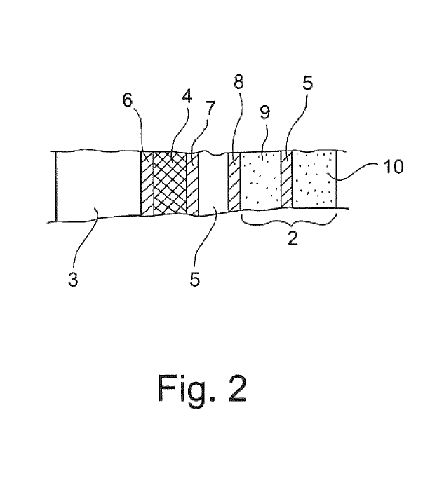

FIG. 2 depicts a second embodiment of the invention. Layers corresponding to those of the embodiment of FIG. 1 have the same reference signs in this embodiment. The second embodiment of the invention differs from the first embodiment in that the first structure-providing external layer 2 is itself of multilayer design. This layer consists of a fiber composite material comprising a first fiber layer 9 and a second fiber layer 10 respectively embedded into a matrix material in the form of a thermoplastic or thermoset plastic and separated from one another by an intermediate layer 5 as cracking-resistant intermediate layer. The intermediate layer 5 has adhesive bonding to the fiber layers 9, 10, optionally by way of further adhesion promoter layers.

### KEY

1 Multilayer composite material
2 First structure-providing external layer
3 Second structure-providing external layer
4 First intermediate layer
5 Second intermediate layer
6 First adhesion promoting layer
7 Second adhesion promoting layer
8 Third adhesion promoting layer
9 First fiber layer
10 Second fiber layer

What is claimed is:

1. A multilayer composite material comprising:
a first structure-providing, self-supporting rigid external layer made of a fiber composite material;
a second structure-providing external layer;
a cracking-resistant intermediate layer made of a plastic selected from a group, comprising cracking-resistance-modified polyethylene, polyisobutylene, prestretched polypropylene, polyvinyl butyral, ethylene-vinyl acetate, polyacrylate, polymethylene acrylate, polyurethane, polyvinyl acetate and ethylene-vinyl acetate; and
at least one adhesion promoter layer,
where the cracking-resistant intermediate layer and the adhesion promoter layer are embedded between the structure-providing external layers and form an adhesion bond with the structure-providing external layers, and where a thickness of each of the structure-providing external layers is greater than a thickness of at least one of the cracking-resistant intermediate layer or of the adhesion promoter layer.

2. The multilayer composite material as claimed in claim 1, wherein there is a further intermediate layer provided, made of a barrier plastic.

3. The multiplayer composite material as claimed in claim 1, wherein the second structure-providing external layer comprises one or more thermoplastics selected from a group comprising polyethylene, polyamide, polyphenylene sulfide, polybutylene terephthalate, polyketone, polyether-etherketone, liquid-crystal polymer and polyphthalamide.

4. The multilayer composite material as claimed in claim 1, wherein the fiber composite material comprises a material with a matrix with at least one of long fibers or continuous-filament fibers embedded therein, where the long fibers or the continuous-filament fibers are selected from a group comprising at least one of glass fibers, carbon fibers or aramid fibers, and the long fibers or continuous-filament fibers have been at least one of woven or laid.

5. The multilayer composite material as claimed in claim 2, wherein the barrier plastic is selected from a group comprising polyvinylidene chloride, ethylene-vinyl alcohol copolymer, a liquid-crystalline plastic, polyamide, cellulose and biaxially oriented polypropylene.

6. The multilayer composite material as claimed in claim 1, wherein the adhesion promoter layer comprises a maleic-anhydride-modified LDPE or an LLDPE.

7. The multilayer composite material as claimed in claim 1, comprises a layer structure comprising, in the following sequence, an exterior layer made of a thermoplastic selected from a group comprising polyethylene, polyamides, polyphenylene sulfides, polybutylene terephthalates, polyketones, polyetheretherketones, liquid-crystal polymers and polyphthalamides, a cracking-resistant intermediate layer and a structure-providing external layer made of a fiber composite material.

8. The multilayer composite material as claimed in claim 1, comprises a layer structure comprising, in the following sequence, an exterior layer made of a thermoplastic selected from a group comprising polyethylene, polyamides, polyphenylene sulfides, polybutylene terephthalates, polyketones, polyetheretherketones, liquid-crystal polymers and polyphthalamides, an adjoining first adhesion promoter layer, an intermediate layer made of a barrier plastic, a second adhesion promoter layer, a cracking-resistant intermediate layer, a third adhesion promoter layer, and a structure-providing external layer made of a fiber composite material.

9. The multilayer composite material as claimed in claim 1, wherein the thickness of the structure-providing external layers is from 0.5 to 2 mm, and that the thickness of the cracking-resistant intermediate layer, and also of the adhesion promoter layer is from 50 μm to 1520 μm.

10. A container made of a multilayer composite material with the features of claim 1, where the first structure-providing external layer is an external layer of the container and the second structure-providing external layer is an internal layer of the container.

11. The container as claimed in claim 10 is a fuel container for a motor vehicle.

12. The container as claimed in claim 10, wherein this is composed of two shell-shaped moldings comprising an upper shell and a lower shell.

13. A process for the production of a container made of a multilayer composite material with the features of claim 1, comprising the following steps:
provision of semifinished fiber-matrix products as fiber composite material;
heating and plastification of the semifinished fiber-matrix products;
molding of the semifinished fiber-matrix products to give shell-shaped intermediate products;
provision of a multilayer plastified extrudate comprising a structure-providing external layer made of a thermoplastic selected from a group comprising polyethylene, polyamides; polyphenylene sulfides, polybutylene terephthalates, polyketones, polyetheretherketones, liquid-crystal polymers and polyphthalamides and a cracking-resistant intermediate layer; and
introduction of the plastic extrudate into the plastified and molded semifinished fiber-matrix product and coherent bonding of the semifinished fiber-matrix product and of the extrudate with utilization of the heat of plastification and/or by an adhesion promoter.
